(19) United States
(12) Patent Application Publication
(10) Pub. No.: US 2008/0169037 A1
(43) Pub. Date: Jul. 17, 2008

(54) Cryogenic bayonet connection

(75) Inventor: Alan T. Ziegler, Santa Cruz, CA (US)

Correspondence Address: Lawrence Edelman;The Law Office of Lawrence Edelman, 130 San Aleso Avenue, San Francisco, CA, 94127, US

(73) Assignee: Cryotech International, Inc.

(21) Appl. No.: 11/654,700

(22) Filed: Jan. 17, 2007

(51) Int. Cl. F16L 59/14; F16L 39/00; B23P 17/04

(52) U.S. Cl. 138/149; 285/47; 29/592; 138/148

(57) ABSTRACT

An improved system is provided for connecting thermally insulated cryogenic delivery piping including a bayonet coupler comprising a thermally insulated section of dual walled piping, said dual walled piping having an annular space between the walls of said piping, the annular space maintained at high vacuum, said bayonet coupler sized to be securely received by internal sleeves disposed at the to-be-joined ends of said cryogenic delivery piping.

### BACKGROUND OF THE INVENTION

1. Field of the Invention

This invention relates generally to cryogenic fluid handling equipment such as cryogenic injection equipment, and more particularly to an improved bayonet member for joining transport conduits used to transport cryogenic fluids for use with such injection equipment, and a method for fabricating same.

2. Description of the Related Art

Traditional cryogenic delivery systems such as disclosed in our pending U.S. application Ser. No. 10/890,246, employ the use of cryogenic piping to deliver cryogenic fluids such as liquid nitrogen from a cryogenic liquid source to the point of use. Traditional cryogenic piping systems are comprised of several components. These components comprise individual sections of piping of specific lengths. Also employed with these piping components are tee fittings, elbows, end fittings and other components that are either thermally passive or active in design. An example of an active device would be a nitrogen dosing devise. A passive device would be a gas venting device.

Cryogenic components without thermal insulation either condensate moisture present in the air, or in worse cases frost over or freeze. As many cryogenic piping applications are inside of occupied buildings, it is desirable and sometimes required to have the piping system be condensation and ice free.

The traditional method to achieve this has been to vacuum insulate the inner carrier pipe (the pipe or tube portion containing the cryogen) from the outside environment using a jacketing pipe. Some commercially available vacuum insulation alternatives include vacuum jacketed pipe (VJP) made by VBC of Woburn MA, SIV Super insulated Vacuum lines made by DeMaco Company, Netherlands, Vacuum Insulated piping (VIP), made by AMKO and others. Vacuum insulation combined with radiation shielding, such as Superinsulation, or Multiple Layer Insulation (MLI) or “wrapping” has been proven to be particularly effective in keeping the cryogen cold in the inner carrier pipe, while at the same time maintaining the outer pipe or jacket relatively warm when compared to the ambient temperature.

Typical temperature measures of “jacket” temperatures range from 1 to 5 degrees C. below ambient. In general, to maintain a condensation free system, the exterior of the pipe cannot exceed 8 degrees C. below ambient.

Cryogenic components are typically built, evacuated, and tested in the cryogenic pipe manufacturer's location, and shipped to the end customer for installation. For shipping purposes, the normal maximum length of pipe which can be easily handled is limited to about 20 feet, though in special circumstances, sections up to 40 feet can be provided, with special arrangements required for shipping. The other passive and active components such as tees, elbows, end fittings, gas venting units, and the like are considerably smaller and do not present the same shipping limitations.

The typical way of connecting any two cryogenic piping components together is by extending the heat path length using what is commercially referred to as a “bayonet” or “cryogenic coupler”. The bayonet is essentially an extension to a first portion of a cryogenic pipe, which is used to connect to a second portion of a second cryogenic pipe. At the point of connection, there is a gasket or other means to provide a gas seal. By the nature of the length of the extension, a long thermal path is created keeping the gas seal portion of the connection warm.

To provide the continuous thermal path there must be an extension (bayonet) at each connection point. The structure of the prior art used to achieve this thus ends up being polarized. That is, where one end is different from the other, the different ends referred to as either “male” or “female”, in a manner similar to more conventional mechanical piping systems. The fact that each end must be specified as either male or female means that the system designer must keep track of the “gender” of the joints throughout the duration of an assembly project, as well as for any future expansions of the system.

One problem with the bayonet systems of the prior art is that inventory control becomes critical to assure there are sufficient male and female pipe terminals in order to avoid delays in assembly should one part or the other not be available at the time. Another problem is that they introduce an element of heat gain at each connection. That is, for every connection used there is a loss of 10-15 BTU.

### SUMMARY OF THE INVENTION

By way of this invention an improved bayonet connection is provided of unique construction which results in simplification of assembly, and to a limited extent, a reduction of heat loss. This is achieved in part by the use of a specialized, cryogenic bayonet coupler having a sealed vacuum as an insulator, the coupler of the same diameter as the male bayonet component which it replaces. In the assembly of a piping system, the bayonet coupler is inserted into each of the open ends of opposing female terminated end sections of cryogenic pipe, the female ends then brought together, clamped and sealed to complete the connection.

The vacuum insulated bayonet coupler is comprised of an inner, carrier pipe having a first and second end, and an outer bayonet jacketing pipe of essentially the same length which is spaced from and surrounds the inner carrier pipe along its length to define an annular space between them. In an embodiment of the invention, additional thermal protection is provided by wrapping the outer wall of the inner pipe with one or more layers of insulation which can include thin layers of reflective foil.

The vacuum is obtained during the manufacture of the bayonet coupler. Joining of the coupler's inner and outer pipes at a first end is achieved by welding the pipe sections together, in a welding step which is usually performed at atmosphere. The thus welded pipe is then placed in a vacuum chamber to bring the annular space between the pipes to vacuum. Then the second end is sealed. This sealing step is achieved by welding in vacuum using standard electron beam vacuum welding techniques. In an embodiment of the invention, an annular ring is inserted at each end between the inner and outer pipe to securely space them, the ring then welded in place. In another embodiment, the inner, carrier pipe is flanged at its first and second ends to close over the annular space between the inner and outer pipe. An advantage of this embodiment is that only one rather than two vacuum welds are required to complete the sealing process.

### BRIEF DESCRIPTION OF THE DRAWINGS

So that the above-recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a three dimensional exploded view of two sections of cryogenic pipe and standard industrial bayonet connection, according to the prior art.

FIG. 2 is a three dimensional view of the same two sections of cryogenic pipe, wherein the two sections are illustrated in assembled form, joined and clamped together.

FIG. 3 A is a sectional view of a connected section of cryogenic pipe of FIGS. 1 and 2, according to the methods of the prior art. FIG. 3 B is a sectional view of the male bayonet component, and 3 C is a sectional view of the female bayonet component.

FIG. 4 is a three dimensional, exploded view of the connection system of this invention including the specialized jacketed bayonet coupler of the invention.

FIG. 5 is an enlarged view of a cross section of an embodiment of the bayonet coupler of the invention.

FIG. 6 is an enlarged view of an end of the bayonet coupler of the invention illustrating two options which can be employed to seal the ends of the inner and outer pipes of the coupler of the invention.

FIG. 7 is a cross section of the connection system of the invention illustrating the components in joined relationship.

### DETAILED DESCRIPTION OF THE INVENTION

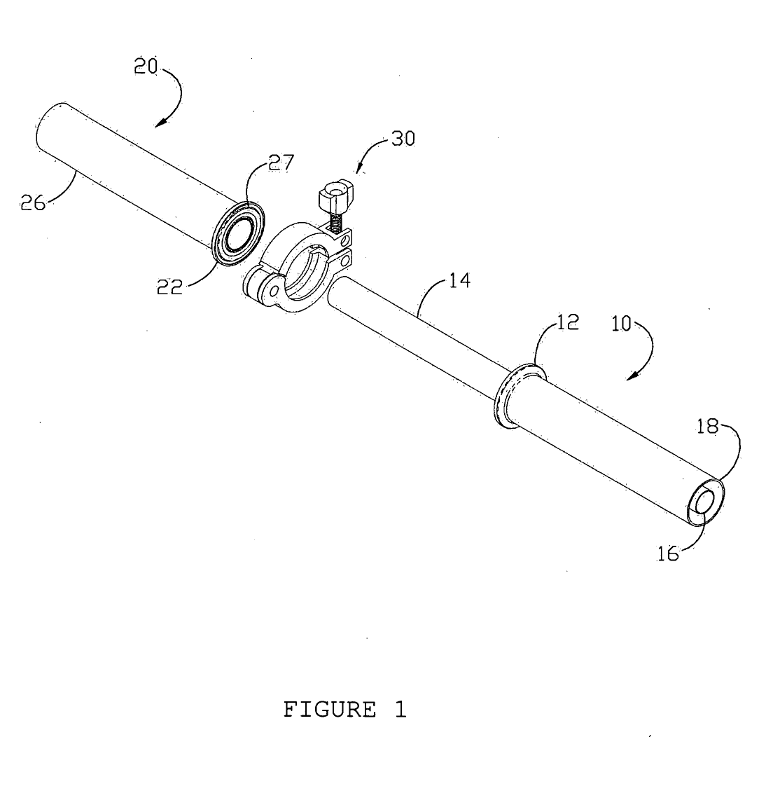

With reference now to FIG. 1 through 3, illustrating a connection system of the prior art, the end of a male cryogenic transport pipe section 10 is shown, ending in terminal flange 12 at its one end, and including male bayonet member 14 extending a defined distance beyond terminal flange 12. Cryogenic pipe section 10 actually comprises two pipes: a first inner or liquid carrier pipe or tube 16 which serves as the transport for the liquid cryogen, and a second outer, jacketing pipe or tube 18. In one embodiment carrier pipe 16 can be wrapped with a radiation shielding material. In another embodiment, the annular space between the inner, carrier pipe and the outer jacketing pipe in maintained at vacuum.

Female cryogenic transport pipe section 20 is similar to pipe section 10, and is provided with a matching terminal flange 22. Like pipe section 10, pipe section 20 comprises an inner cryogenic liquid carrier pipe or tube 24 of generally the same diameter as pipe 16, and an outer jacketing pipe or tube 26 of generally the same diameter as outer pipe 18 of pipe section 10.

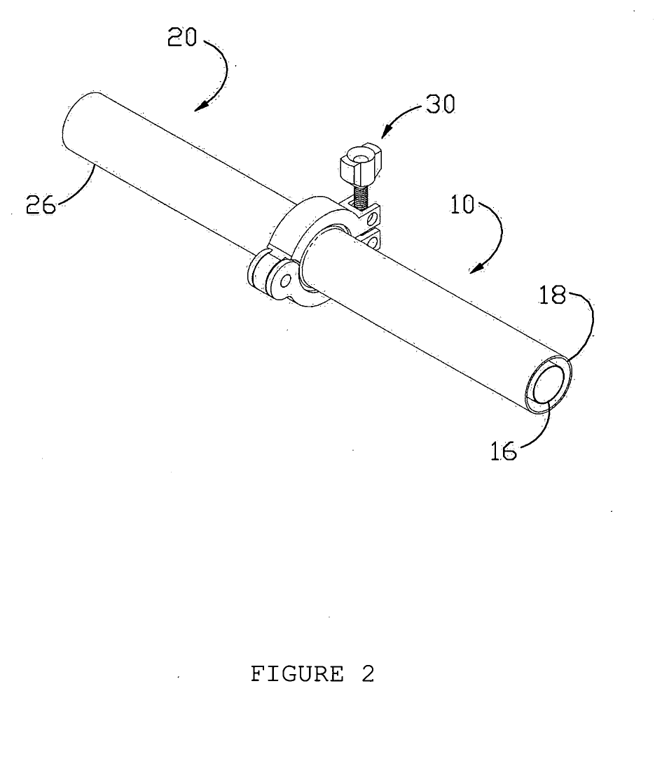

The faces of both terminal flanges 12 and 22 include a circular groove 27, sized to receive a sealing gasket 28. In FIG. 2, the two cryogenic pipe sections 10 and 20 are shown in connected relationship, the faces of flanges 12 and 22 up against each other, gasket 28 in place to assure a gas-tight seal, and clamp 30 secured in place over the opposing flanges.

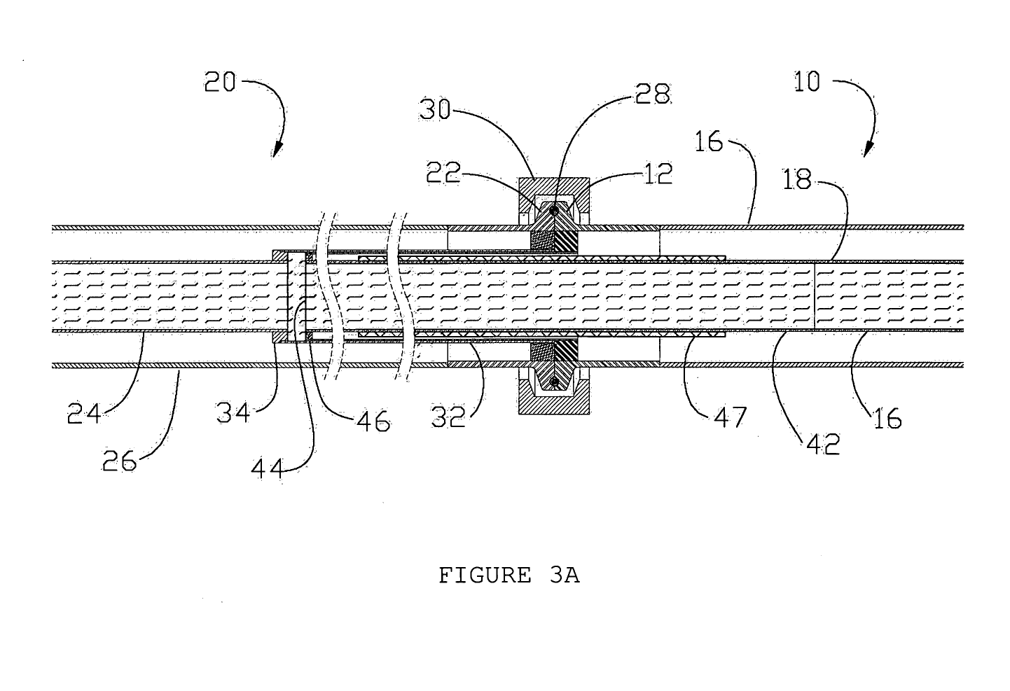

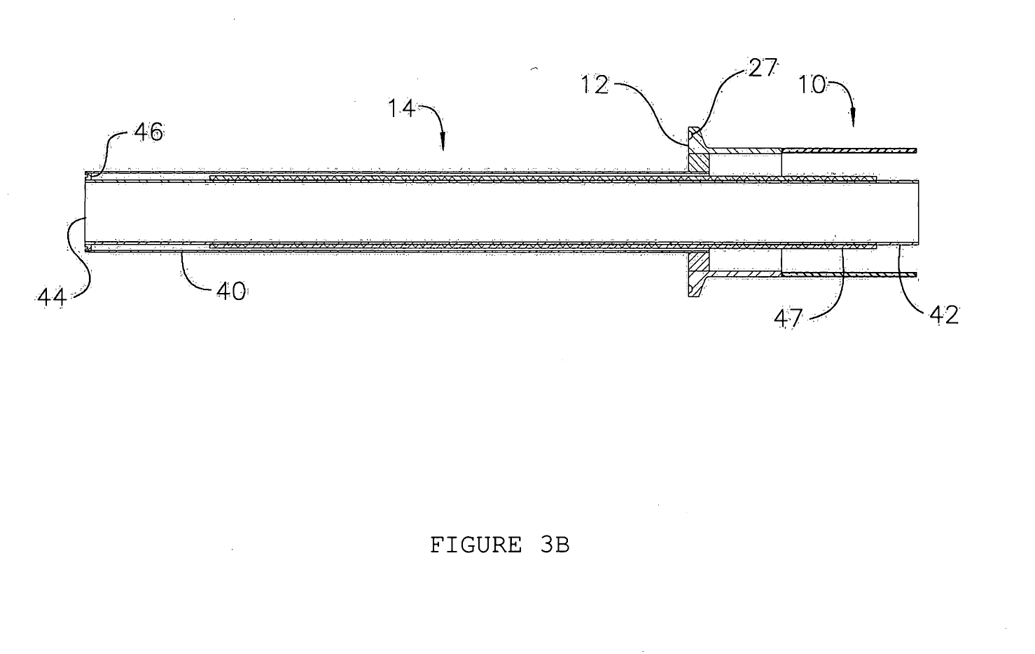

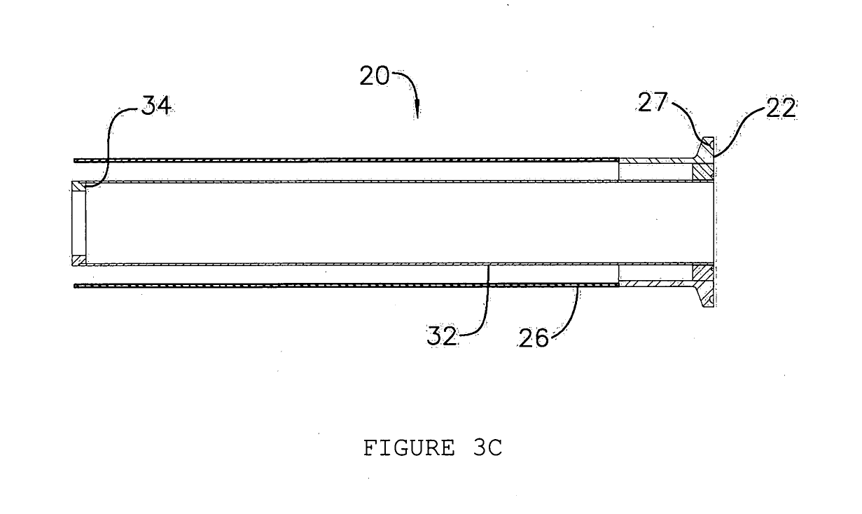

FIG. 3 illustrates transport pipe sections 10 and 20 in cross section, secured together as shown in FIG. 2, with the interior of the connection depicted. As shown, female sleeve 32 extends rearward a defined distance from the face of flange 22, terminating at end section 34, this end section of a reduced cross section, and sized to securely receive internal carrier pipe 24. The inner diameter of female bayonet sleeve 32 is provided such that its inner diameter is slightly larger than the outer diameter of bayonet member 14, and thus securely receives the male bayonet member.

Bayonet member 14 comprises two pipes, a male outer bayonet pipe section or jacket 40 and a male inner bayonet pipe section 42. The outer pipe section 40 is sized to be securely received by female bayonet sleeve 32. The inner bayonet pipe section 42 is of smaller diameter than outer bayonet pipe section 40, so as to define an annular space between the two pipes. Note that in the embodiment depicted in FIG. 3, outer pipe section 40 extends from flange 12, while inner pipe section 42 is of similar diameter to carrier pipe 16, and in one embodiment can be an extension of this pipe.

At terminus 44 of inner and outer bayonet pipe sections 40 and 42 is an annular plug 46 which spaces the end of the pipe sections one from the other and provides a vacuum seal when welded in place, such that the vacuum which exists between carrier pipe 16 and outer pipe 18 extends into the annular space between pipe sections 40 and 42. In the embodiment shown in the figure, male inner bayonet pipe section 42 may be wrapped with a radiation shielding material 47 to improve the thermal isolation of liquid cryogen being transported within the carrier pipe.

As illustrated in FIG. 3, the flanged end sections of pipes 10 and 20 are of separate constructions, which constructions are welded to and become integral to the cryogenic piping as part of the manufacturing process. This is done for ease of fabrication. It should be appreciated that the manner of construction is a matter of engineering choice, and is depicted in the figure for the purpose of illustration only.

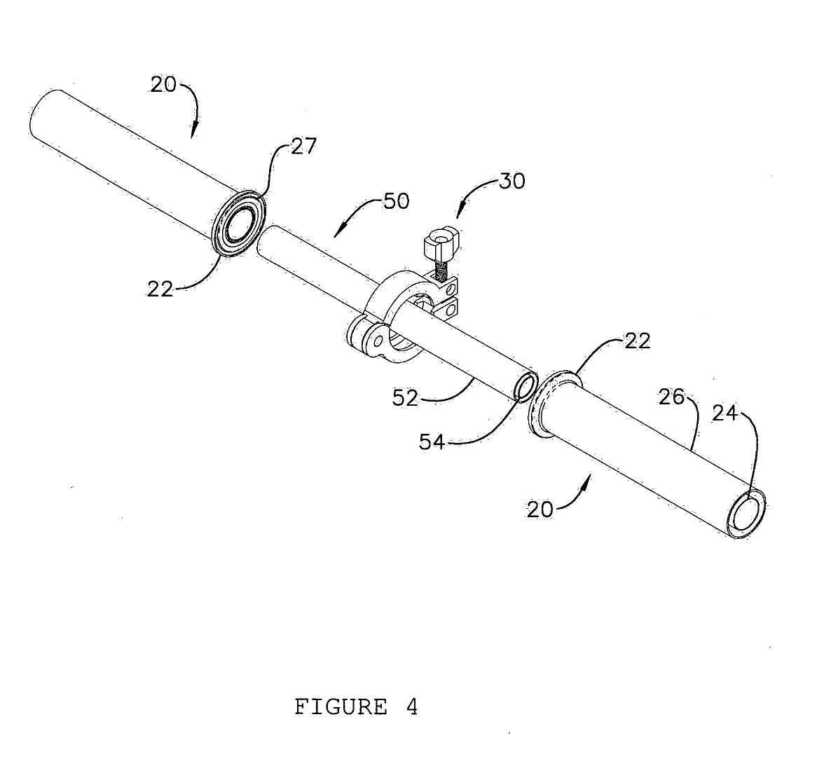

The improved system of this invention will now be discussed, with reference to FIGS. 4 through 7. By way of this invention, a stand alone bayonet coupler comprising a single length of jacketed piping section 50 is provided which can be inserted into the ends of a female terminated type pipe section 20, thus eliminating the need for matching male to female piping sections. The construction of cryogenic pipe section 20 is the same as in the previous discussion of the prior art, with the pipe section 20, including sleeve 32, and terminating in flange 22, the flange provided with a circular groove 27 for receiving a sealing gasket 28. To complete the assembly, jacketed piping section 50 is inserted equidistant into opposing female pipe sections 20, the center point of pipe 50 indicated by marking means, not shown. For example, to properly insert the jacketed coupler, a scribed mark on the surface of and at the center of the pipe can be provided. Alternatively, a hard stop can be mechanically provided such as a post positioned at the center point along the length of the pipe, the flanges provided with a recess to receive the post. Other techniques will be apparent to those of ordinary skill in the art, and the particular technique used to denote the longitudinal center point of the coupler is not critical to this invention. The two sections of pipe are secured together by clamp 30, in the secure position the opposing flanges 22 in an abutting and gas sealed relationship one to the other.

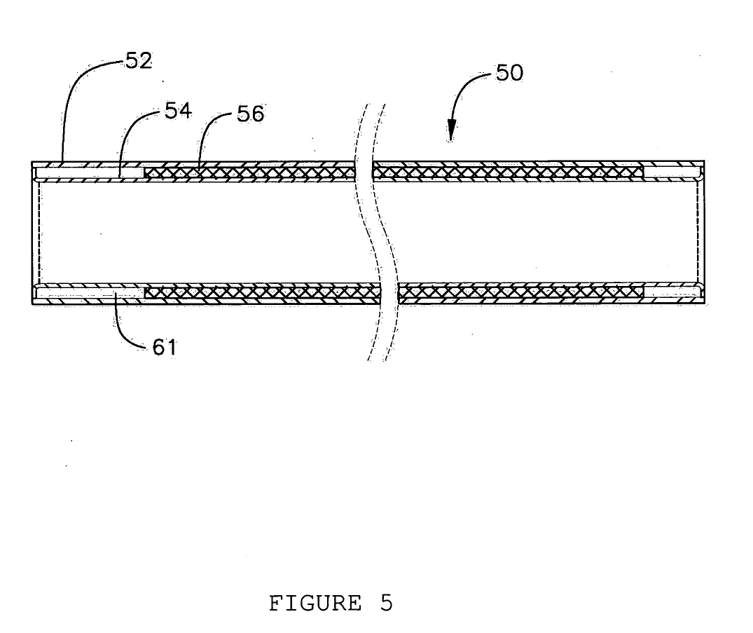

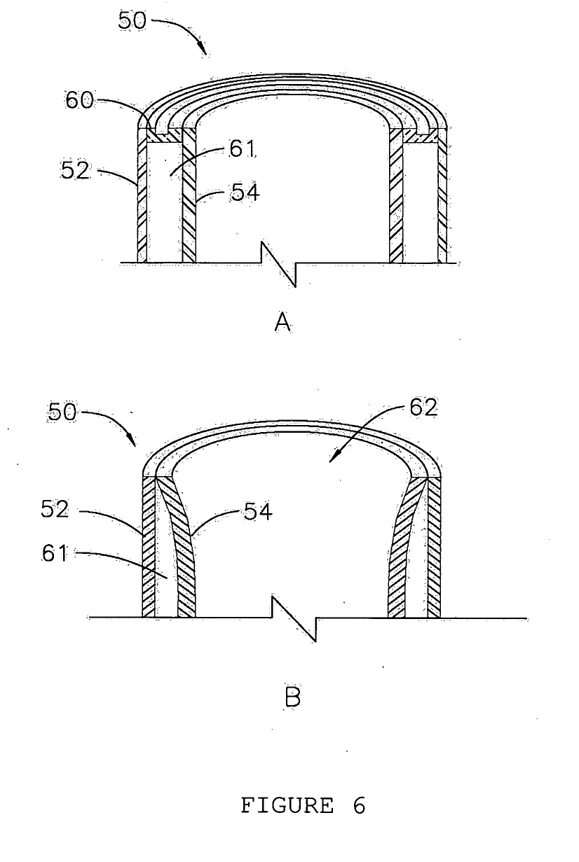

With reference to FIG. 5, a cutaway of coupler 50 is illustrated. Coupler 50 comprises a male outer pipe section or jacket 52, and an inner male carrier pipe section 54. The outer dimension of carrier pipe section 54 is smaller than that the inner dimension of jacket 52 so as to define an annular space 61 between them. In one embodiment of this invention, the outer wall of inner male carrier pipe 54 can be wrapped with a radiation shielding material 56 to further thermally insulate the carrier pipe from jacket 52. This shielding material, which can be the same as or different from shielding material 47, can be a reflective material such as that commercially available from companies like Lydall, N.Y. which sells a foil wrap under the trade name CRS Wrap. CRS Wrap comprises thin layers of reflective foil coated onto thin layers of fiberglass, with the layers of glass and foil in physical contact but not bonded each to the other. As shown in the figure, the insulation is wrapped around the pipe and extended to near, but not to its ends. This is done to prevent the melting of the insulation in the fabrication step, later described. Also, as shown in the figure, the ends of coupler 50 are terminated in the manner further described in connection with the embodiment of FIG. 6 B.

Annular space 61 between jacket 52 and carrier pipe 54 is maintained in vacuum to further improve the thermal insulation of the assembly. The vacuum is provided in the process of fabrication of the pipe, as will be hereinafter explained. The achieving and maintaining of the vacuum, in an embodiment of the invention can be further improved by incorporating commonly available gettering agents, such as zeolites, into the space between the pipes. When a radiation shielding material is provided, a gettering agent in powdered form can be sprinkled over the last layer of the shielding material and left inside of the tube. The gettering agent will continue to pull out remaining gas molecules and outgassed hydrogen present in the metal tubing itself.

With reference to FIG. 6, two means of terminating the end of coupler 50 are illustrated. Referring first to FIG. 6A, an end of coupler 50 is illustrated, with outer pipe or jacket 52 surrounding and spaced from inner carrier pipe 54. A spacer plug 60 (which may be the same or different than spacer plug 46) is shown inserted between the outer wall of inner carrier pipe 54 and the inner wall of jacket 52. In assembly, spacer plug 60 is sized to be pressure fit into both ends of coupler 50. In the fabrication of coupler 50, plugs 60 are eventually welded in place.

Referring next to FIG. 6B, another embodiment is illustrated wherein the need for a spacer plug is eliminated, the terminal wall 62 of carrier pipe 54, flanged outwardly a distance sufficient to span the gap between the outer wall of inner pipe 54 and the inner wall of the outer pipe 52, the inner pipe welded to the outer pipe at both ends to close off and vacuum seal the assembly. As an advantage to this second embodiment, only two rather than four welds are required in the fabrication process.

To manufacture male coupler 50, the inner pipe 54 is first positioned inside of outer pipe 52. In the one embodiment, annular spacer plug 60 is inserted at a first end of pipe 50, and welded in place using two welds. In another embodiment, inner pipe 54 having flanged end 62 is positioned within outer pipe 52 and a single weld applied to join the pipes at a first end. These welds may be performed at atmosphere.

The thus welded tube is then placed in a vacuum welding chamber and the space between the pipes evacuated to a high vacuum, such as between about 10⁻² to 10⁻⁴ Torr. In the usual case evacuation is carried out until a vacuum of about 10⁻³ torr is obtained. Because of the small clearances involved, and especially in the case of the presence of the insulated wrapping material, the evacuation process may take one to several days.

Once vacuum is achieved, the second end of the connecting pipe is electron beam welded closed. In the case of the embodiment of FIG. 6A, two e-beam welds are required. In the case of the embodiment of FIG. 6B, but one e-beam weld is required. The e-beam welder may be any one of those commercially available, and the welding carried out according to standard e-beam welding protocols. In one approach, the electron beam is held stationary and the part is moved beneath the beam to achieve the weld in vacuum. In another approach, the part can be stationary and the beam moved along the path to be welded. The result of this operation is the production of a jacketed pipe coupler having a high vacuum in the annular space between the inner and outer pipes, and the ends hermetically sealed to maintain vacuum. In an embodiment, the jacketed pipe is also provided with reflective insulation between the inner and out pipe to further enhance the thermal properties of the coupler.

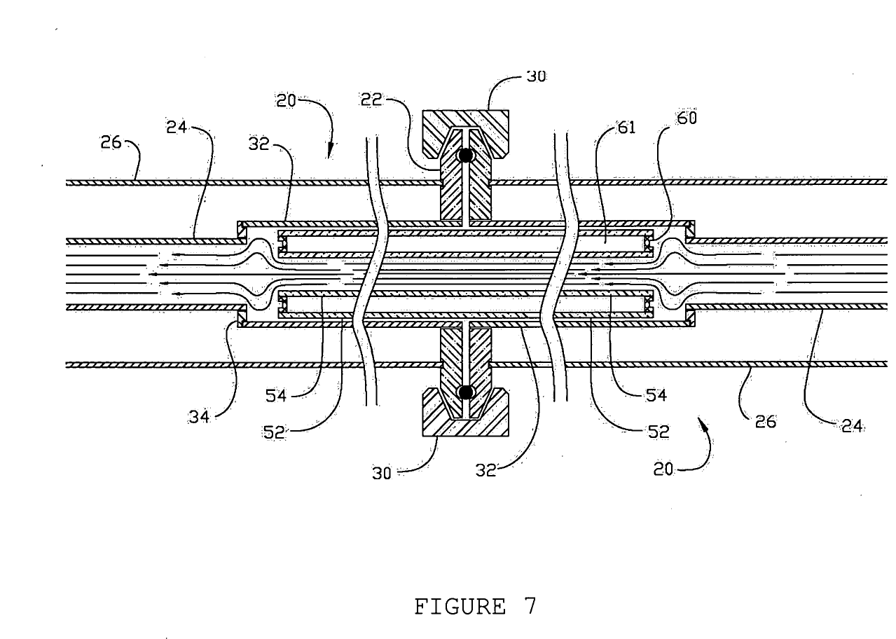

In FIG. 7 the components of the invention are shown in assembled form, with coupler 50 inserted into sleeve 32 of each female section of pipe 20. The various components in their engaged relationship with each other are as indicated in the figure.

To the extent the length of coupler 50 is less than the overall internal longitudinal dimension of the opposing sleeves 32, an enlarged annular space may exist between the end of sleeve 32 and the end of coupler 50. As sown in FIG. 7, when cryogenic fluid passes through the junction of such an assembly, the fluid volume will expand to fill this space and then contract as it continues its passage through the interior of coupling member 50. The degree of such expansion and contraction has been exaggerated in the drawings (where the parts are not drawn to scale) in order to better illustrate the inter-relationship of the various coupling components. To the extent such expansion and contraction occurs, it does not materially affect either the flow of cryogenic fluid, or the thermodynamic properties of the junction.

By way of this invention a simpler cryogenic liquid piping delivery system is provided which provides a better insulated connection, and is easier to install in the field as only one type of cryogenic piping is required. In addition, it is easier to expand or extend an existing system as fewer component parts are involved.

While the foregoing is directed to embodiments of the present invention, other and further embodiments of the invention may be devised without departing from the basic scope thereof, and the scope thereof is determined by the claims that follow.

What I claim is:

1. A thermally insulated cryogenic coupler including:
a section of inner piping having a first and second end;
a section of outer piping having a first and second end, the first and second ends substantially coterminous with the first and second ends of the said section of inner piping, wherein the internal diameter of said outer section of piping is larger than the outer diameter of said inner section of piping, said section of inner piping positioned within said section of outer piping;
the said sections of said inner and outer piping joined one to the other at their first and second ends to define a closed, hermetically sealed annular space between said inner and outer sections of piping; whereby,
a condition of vacuum is provided and maintained between the inner and outer sections of said piping.

2. The insulated cryogenic coupler of claim 1 wherein the vacuum is a high vacuum.

3. The insulated cryogenic coupler of claim 2 wherein the high vacuum is between 10⁻² torr to 10⁻⁴ torr.

4. The insulated cryogenic coupler of claim 1 wherein the section of inner piping is wrapped with one or more layers of an insulating material.

5. The insulated cryogenic coupler of claim 4 wherein the insulating material is a reflective foil.

6. The insulated cryogenic insulated coupler of claim 1 wherein the inner and outer sections of said piping are joined at their first and second ends by an annular-ring type spacer plug whose inner diameter is sized to receive the outer wall of said section of inner piping, and whose outer diameter is sized to be received by the inner wall of said section of outer of piping, the spacer plug fixedly secured in place.

7. The insulated cryogenic coupler of claim 1 wherein the said inner section of piping is outwardly flared at its first and second ends, said outwardly flared ends sized to be of a diameter slightly smaller than the inner diameter of said outer piping section, whereby said inner and outer sections of piping are joined at their first and second ends by welding of said flared ends to the inner wall of said outer section of piping.

8. The insulated cryogenic coupler of claim 3 wherein within the space between the inner and outer sections of piping contains a gettering material.

9. The insulated cryogenic coupler of claim 1 wherein the longitudinal center point of the pipe is indicated by a central marking.

10. The insulated cryogenic coupler of claim 9 wherein said central marking is a radially extending post.

11. In a cryogenic fluid delivery system, a connecting assembly having a first section of insulated transport pipe, including an internal receiving sleeve, and a second section of insulated transport pipe including an internal receiving sleeve, each of said first and second sections of insulated pipe terminating in a flanged end section, and means for coupling the two said pipe sections together at their flanged ends, the improvement comprising:
a jacketed piping insert, said piping insert comprising a section of pipe including an inner pipe and an outer pipe, the inner pipe spaced from the outer pipe to define an annular space between them, said jacketed piping insert vacuum sealed to define a vacuum within said annular space, the jacketed piping insert having a diameter sized so as to be received by each of said receiving sleeves of said sections of insulated pipe.

12. The connecting assembly of claim 11 wherein the jacketed piping insert extends equidistant into each of the receiving sleeves of said insulated transport pipe sections.

13. A method for fabricating the thermally insulated cryogenic coupler of claim 1 wherein:
the sections of inner and outer piping are first sealed in atmosphere at a first end;
the annular space between the pipes is next evacuated; and,
the second ends of the pipes are thereafter sealed one to the other in vacuum.

14. The method of claim 13 in which the second ends of the pipes are sealed in vacuum by an e-beam weld carried out in vacuum.

15. The method of claim 13 in which the first and second ends of pipe are hermetically sealed.

16. The method of claim 13 wherein the annular spaced is evacuated to high vacuum prior to sealing of the pipes at their second ends.

17. The method of claim 15 wherein the annular space is evacuated to 10⁻² to 10⁻⁴ Torr prior to sealing.
